(19) United States
(12) Patent Application Publication
(10) Pub. No.: US 2007/0292235 A1
(43) Pub. Date: Dec. 20, 2007

(54) Self-Drilling Reaming Screw for Hard Materials

(76) Inventor: Katsumi Shinjo, Okasa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/756,658

(22) Filed: Jun. 1, 2007

(30) Foreign Application Priority Data
Jun. 15, 2006 (JP) JP 2006-165761

(51) Int. Cl. F16B 35/00

(52) U.S. Cl. 411/386

(57) ABSTRACT

A self-drilling reaming screw for hard materials such as hard woods or plywood boards each covered with a rigid surface layer has a threaded portion (8) continuing to a drill bit (7), and a non-threaded shank (3) continuing from the threaded portion. The screw has also a conical head (4) continuing from the shank, and a reaming portion (6) is composed of blades protruding out from the shank in opposite radial directions, with each blade (6) being so thick as to be protected from the hard materials (21). The reaming portion has a diameter (W) smaller than but close to the diameter (D) of conical head, and larger than but not close to the diameter (d) of threaded portion. The drill bit (7) forms a rough hole (23) that is then tapped by the threaded portion (8) to give a female-threaded hole (24). The reaming portion (6) enlarges the threaded hole to form a guide hole (25), such that the conical head (4) is forced into it and buried in the hard material.

### FIELD OF THE INVENTION

The present invention relates to a self-drilling reaming screw used to secure any hard materials to a soft support such as an aluminum plate, a thin steel plate, a plastics plate or the like, wherein the hard materials may be hardwoods, plywood boards each covered with a rigid surface layer.

### BACKGROUND ART

Some self-drilling reaming screws adapted for fixedly attaching any wood parts or plywood members on a metal plate or sheet are known in the art as shown for example in the Patent References No. 1 to No. 3 listed below.

Self-drilling reaming screws of the conventional types are suited to consolidate a relatively soft wood or plywood member with a relatively hard steel plate or the like. They usually have a conical head and a reaming portion formed on a drill bit or between the drill bit and a threaded region. The reaming portion consists of blades protruding sideways and radially from the threaded region's periphery. The drill bit will pierce a rough hole in the wooden member or the like, and subsequently the reaming blades render this hole larger than the diameter of said region. As the drill bit further advances deeper, the reaming blades having collided with the relatively hard support will be broken off. Such a soft woody member having a rough hole bored therein should not injure those blades while they are reaming this hole. Thus, the diameter of reaming portion has been made as small as possible (to be almost the same as, or slightly greater than, the diameter of threaded portion). This feature has brought about a relatively large area for the fastened seating surface of a screw head.

Those prior art self-drilling reaming screws would however encounter certain problems caused by relatively hard materials such as hardwood or plywood boards each covered with a rigid surface layer. Such a hard material may have to be fixed on a relatively soft support such as aluminum plates, thin steel plates or plastics plates. In this case, the reaming blades will rapidly be torn off failing to enlarge a rough hole formed in the hard material. If those blades were thickened to avoid breakage thereof, then the lower softer base or support coming into contact therewith could not break and tear them off. The rough hole thus reamed to have an enlarged diameter will disable the soft support to be tightened with such a screw. Since the soft support does not firmly retain the screw against a strong thrust, its head (particularly, conical head) can not be forced fully into a guide hole thus formed in the upper harder material. As an unfavorable result, such a screw thus loosely fastened will have its head jutting out from the surface of said hard material.

Patent Reference 1 . . . Japan Patent Publication Hei. 5-16930

Patent Reference 2 . . . Patent Laying-Open Gazette Sho. 58-152919

Patent Reference 3 . . . ibid. Hei. 8-42538

### DISCLOSURE OF THE INVENTION

Objects To Be Achieved

An object of the present invention made in view of the above-mentioned problems is to provide a self-drilling reaming screw for securing hard materials to any soft supports such as aluminum plates, thin steel plates, plastics plates or the like. The hard material may be such as hard woods or plywood boards each covered with a rigid surface layer, and the present screw should have its head prevented from jutting out of the surface of said hard material.

Solutions

In order to achieve the object, the invention proposes a self-drilling reaming screw that comprises a threaded portion, a drill bit formed at a distal end of the threaded portion, and a non-threaded shank continuing from a proximal end of the threaded portion. This reaming screw further comprises a conical head formed at a proximal end of the non-threaded shank, and a reaming portion composed of blades. These blades protrude radially from the non-threaded shank and are disposed diametrically opposite to each other. The reaming portion should have an effective diameter smaller than but close to an outer diameter of the conical head, and much greater than an outer diameter of the threaded portion. Also characteristically, thickness of each blade intervening between the conical head and the threaded portion is large enough to protection thereof from the hard materials that would otherwise break the blades. By virtue of these features, the threaded portion is capable of tapping a rough hole formed by the drill bit, before the reaming portion enlarges a resultant female-threaded hole to provide a guide hole. Thus, the head of the screw is surely forced into the guide hole and buried in the hard material.

Diameter of the non-threaded shank may be set larger than the diameter of a columnar region from which the threaded portion is formed by the rolling. This feature enables the shank to have the reaming portion of any desired diameter and thickness.

Also preferably, the reaming portion may be disposed adjacent to the threaded portion for tapping the rough hole. The thus female-threaded hole can be enlarged in diameter in a reliable manner.

Further, the reaming portion may be disposed adjacent to both the threaded portion and the conical head. Even if the hard material is relatively thin, it can nevertheless be fastened surely.

Advantages Afforded Herein

As summarized above, the present self-drilling reaming screw can fasten any hard woods, plywood boards having rigid surfaces or the like hard materials to aluminum plates, thin steel plates, plastics plates or the like soft supports. This screw will not leave its head projected out of the surface of such a hard material.

### BRIEF DESCRIPTION OF THE DRAWINGS

FIG. 1 is a front elevation of a blank for a self-drilling reaming screw to be manufactured herein;

FIG. 2 is a plan view of the blank;

FIG. 3 is a front elevation of the blank partially processed to have a reaming portion;

FIG. 4 is a side elevation of the partially processed blank;

FIG. 5 is a front elevation of the finished self-drilling reaming screw of the invention;

FIG. 6 is a front elevation of the finished screw that is being tightened in use, wherein relevant members are shown in cross section;

FIG. 7 is a front elevation of the finished screw that has been tightened in situ;

FIG. 8 is a cross section taken along the arrow line 8-8 in FIG. 7;

FIG. 9 is a front elevation of a further self-drilling reaming screw provided in another embodiment;

FIG. 10 is a front elevation of the further screw that has been tightened; and

FIG. 11 is a cross section taken along the arrow line 11-11 in FIG. 10.

### THE PREFERRED EMBODIMENTS

Now some embodiments of the present invention will be described referring to the accompanying drawings.

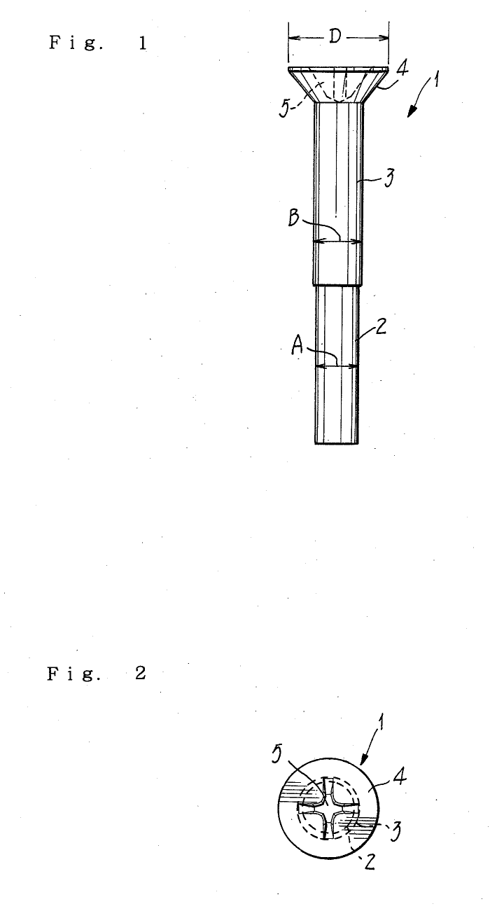

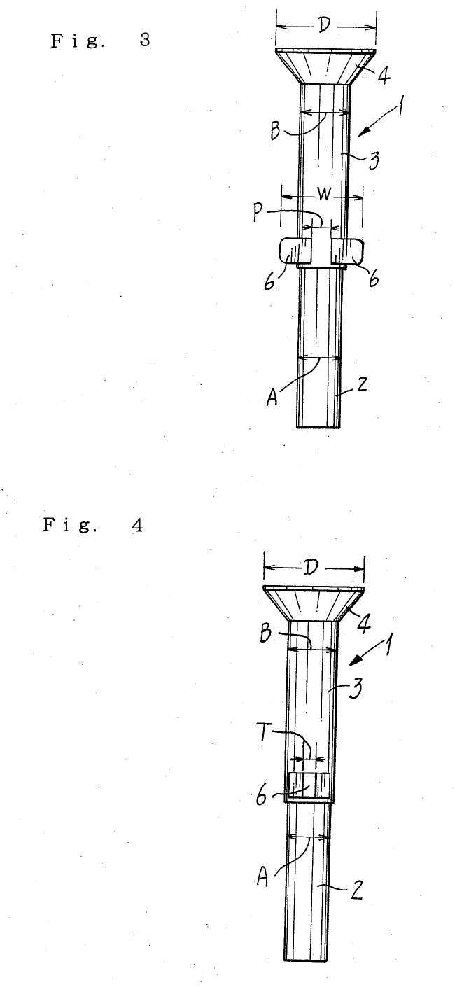

FIGS. 1 to 5 are schemes showing a process for manufacturing a self-drilling reaming screw of the invention. As will be seen in FIGS. 1 and 2, a blank 1 for the screw is prepared using a header for processing a carbon steel rod or the like raw metallic material. The screw blank 1 has a columnar region 2 where a drill bit as well as a threaded portion (detailed below) are to be formed, and continuing from this region 2 is a non-threaded shank 3. A reaming portion (detailed below) will be formed around this non-threaded shank 3 whose upper end is shaped as a conical head 4. A recess 5 in the head 4 is for engagement with a driving tool. The non-threaded shank 3 has a diameter ‘B’ slightly or noticeably greater than diameter ‘A’ of the columnar region 2.

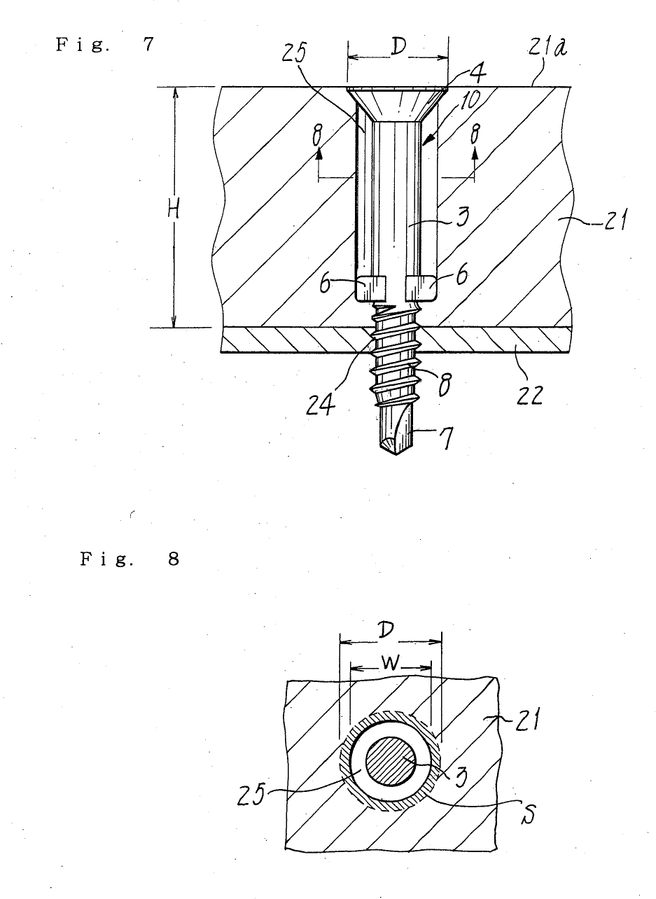

Next, a pair of reaming blades 6 will be formed by the pinch-pointing or the like method on the non-threaded shank 3, at its portion adjoining the columnar region 2. These blades 6 located diametrically opposite to each other do protrude in radial directions. A drill bit 7 will cooperate with a threaded portion 8 to provide a female-threaded hole 24 in a hard material 21 (see FIGS. 6 and 7). In order to enlarge this hole to give a guide hole 25 as discussed below, the circumscribed circle of a reaming portion composed of such blades 6 has a sufficient diameter ‘W’, with each blade having a sufficient thickness ‘T’.

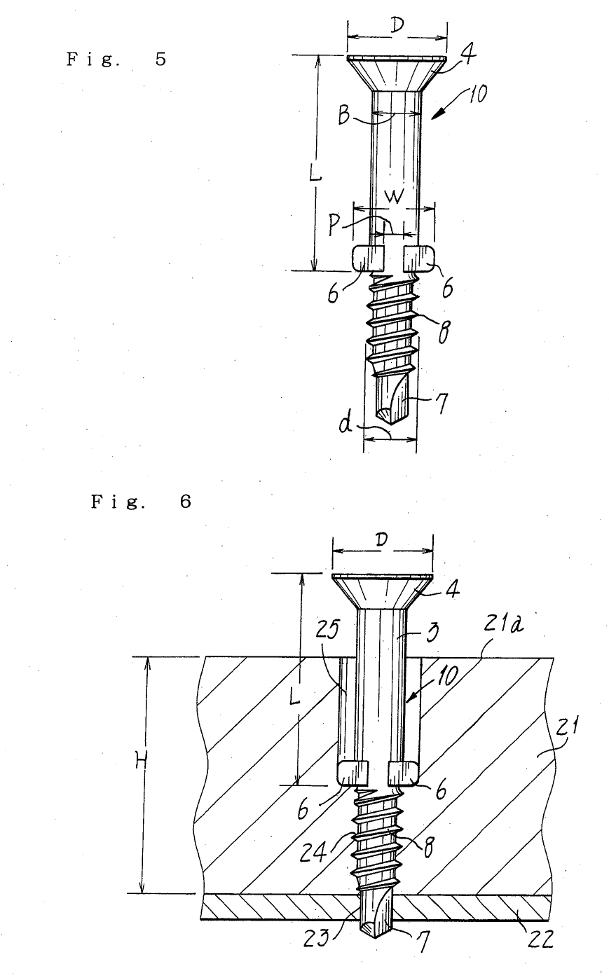

Subsequently, the end of columnar region 2 will be pressed to give the drill bit 7 as shown in FIG. 5. Further, the threaded portion 8 is shaped by the rolling, thus providing a finished self-drilling reaming screw 10 of the invention.

The reaming portion 6 of self-drilling screw 10 has the diameter ‘W’ falling in a range from the outer diameter ‘d’ of threaded portion 8 and the outer diameter ‘D’ of head 4. The value of diameter ‘W’ is much closer to the first diameter ‘D’, and less close to the second one ‘d’. Thickness ‘T’ of the reaming blades 6 is great enough to protect them from breakage while reaming the large-diameter guide hole 25 in hard material 21. Thus, a rough hole will be bored first by the drill bit 7 piercing this material, and this hole is then tapped by the threaded portion 8 so as to provide a female-threaded hole 24. Upon enlargement of this hole 24 by means of reaming portion 6, the conical head 4 will be forced into a resultant enlarged guide hole 25 to such an extent that this head is not left projected from the surface of said material. In order to easily shape such reaming blades 6, the non-threaded shank 3 has a diameter ‘B’ greater than that ‘A’ of the columnar region 2. Also for the same purpose, a distance ‘P’ between the inner or basal ends of those blades 6 facing one another may preferably be about a half or less of the diameter ‘B’ of shank 3. This feature is advantageous in that the non-threaded shank 3 need not be made so extremely thick as compared with the columnar region 2, while ensuring desired values of ‘W’ and ‘T’. On the other hand, the screw's partial length ‘L’ from the top of its head 4 to the bottom of its reaming blades 6 is designed somewhat shorter than thickness ‘H’ of the hard material 21 being fastened (see FIGS. 6 and 7).

In an example case of the self-drilling reaming screw 10 whose threaded portion 8 has a nominal diameter of 4 mm, the diameter ‘A’ of columnar region 2 will be about 3.34 mm as the valley circle diameter of standard M4, and the diameter ‘B’ of non-threaded shank 3 will be about 3.83 mm as the valley circle diameter of standard M5. The reaming portion 6 will have a diameter ‘W’ of about 6.5 mm and a thickness ‘T’ of about 1.0 mm.

FIGS. 6 to 8 show the self-drilling reaming screw 10 in use, wherein the numeral 21 denotes a hard material such as a hardwood or a plywood board covered with a rigid surface layer. The further numeral 22 denotes a softer supporting member such as an aluminum plate or a thin steel plate to which the hard material 21 is to be fixedly attached.

In operation, the drill bit 7 of this screw 10 will pierce a rough hole 23 starting from the surface 21a of hard material 21. The threaded portion 8 will be forced towards the soft support 22 and tightened into the rough hole 23, thereby forming a female-threaded hole 24. As the reaming portion 6 subsequently expands the latter hole 24, it will become a larger-diameter guide hole 25 (of a diameter ‘W’) as shown in FIG. 6. With the drill bit 7 further advancing deeper, a rough hole 23 will be pierced also in and through the soft support 22. The threaded portion 8 will likewise be screwed into this rough hole 23 so as to tap and firmly engage with it. In such a fastened state of the screw 10, its conical head 4 is pressed in its entirety into the mouth of guide hole 25, as seen in FIG. 7. The head 4 is buried in the guide hole 25 so as not to protrude at all from the said surface 21a of hard material 21. The self-drilling reaming screw 10 thus firmly secures the hard material 21 to the soft support 22.

As illustrated in FIG. 8, the head 4 will have an acting surface (or fastening and seating surface) ‘S’ in contact with the hard material 21 when the tightening of the screw 10 is completed. This surface ‘S’ is of an annular configuration whose width depends on a difference between the diameter ‘D’ of head 4 and that ‘W’ of guide hole 25. By making the diameter ‘W’ of reaming portion 6 as large as possible and thus close to the diameter ‘D’, the contact area ‘S’ is rendered much smaller than the ordinary fastening seat of head 4. Due to this feature, the head 4 being pressed towards the interior of guide hole 25 of the hard material 21 can now be buried therein more easily. Because the distance ‘L’ between the top of head 4 and the bottom of reaming blades 6 is somewhat shorter than the thickness ‘H’ of hard material 21, these blades will stand apart from the soft support 22. The reaming portion 6 is thus inhibited from interfering with the support 22, lest the former should injure the latter.

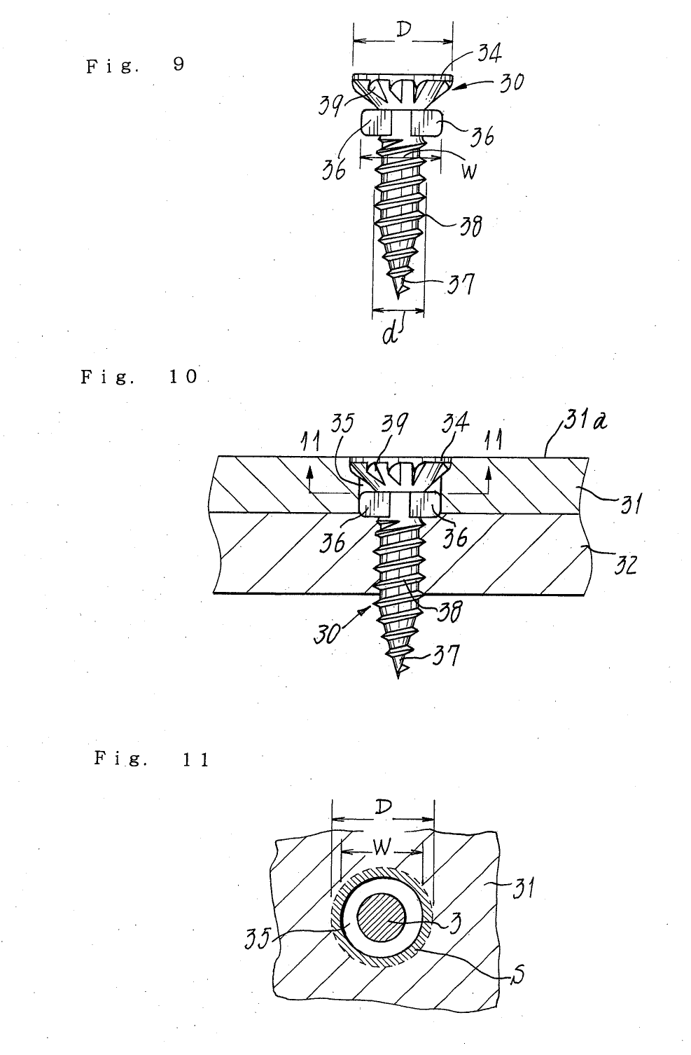

FIGS. 9 to 11 show another embodiment of the invention, wherein a relatively thin hard material 31 is a hard plastics board. This board is reinforced with a glass fiber dispersed in a plastics matrix. The hard material 31 will be adjoined to a softer and thicker support 32 composed of the same or different plastics. A self-drilling reaming screw 30 used herein comprises a threaded portion 38, a pointed drill bit 37 and a conical head 34 continuing from said portion. The drill bit 37 is disposed at a distal end of threaded portion 38. Reaming blades 36 formed integral with a neck of the columnar body are adjacent to both the threaded portion 38 and conical head 34. These blades 36 protruding in radial directions are diametrically opposed one to another. Also in this case, diameter ‘W’ of such a reaming portion 36 is greater than diameter ‘d’ of threaded portion 38 but less than diameter ‘D’ of conical head 34. Such a large value of ‘W’ is much closer to ‘D’ and less close to ‘d’. Also similarly to the first embodiment, thickness ‘T’ of each blade 36 is made great enough not to be broken while reaming a large guide hole 35 in and through the hard material 31. However, the head 34 of this embodiment has at its annular spot-facing seat some countersinking blades 39. By virtue of this feature, the head 34 can be easily pressed into and buried in the guide hole 35.

The pointed drill bit 37 of the self-drilling screw 30 will bore a rough hole in the hard material 31, starting from its top surface 31a. The threaded portion 38 thrust towards the soft support 32 into the rough hole will deform it to a female-threaded hole. The reaming portion 36 will enlarge the latter hole to give a large-diameter guide hole (of a diameter ‘W’). With the drill bit 37 further advancing deeper, another rough hole will be pierced also in the soft support 32. The threaded portion 38 tightened into and through this hole works to fix this screw 30 to the support 32, in a manner shown in FIG. 10. The conical head 34 thus pressed into the guide hole 35 will not have its top projecting up out of the top 3 la of the hard material 31 thus firmly adjoined to said support 32. The countersinking blades 39 on the seating face of head 34 will serve to enlarge the rim of guide hole 35, to thereby facilitate the screwing of the head into this hole.

As shown in FIG. 11 and similarly to the first embodiment, the head 34 has a seating surface ‘S’ in contact with the hard material 31 when the tightening of the screw 30 is completed. This annular surface ‘S’ has a width depending on a difference between the diameter ‘D’ of head 34 and that ‘W’ of guide hole 35. By making largest possible the diameter ‘W’ of reaming portion 36, the contact area ‘S’ is rendered much smaller than the ordinary fastening seat of head 34. Thus, the head 34 being pressed into the guide hole 35 of hard material 31 can be buried therein more easily.

1. A self-drilling reaming screw for hard materials that are selected from a group consisting of hard woods, plywood boards each covered with a rigid surface layer and the like, the screw comprising:
a threaded portion,
a drill bit formed at a distal end of the threaded portion,
a non-threaded shank continuing from a proximal end of the threaded portion,
a conical head formed at a proximal end of the non-threaded shank, and
a reaming portion that is composed of blades protruding radially from the non-threaded shank and diametrically opposite to each other,
wherein the reaming portion has an effective diameter smaller than but close to an outer diameter of the conical head, and much greater than an outer diameter of the threaded portion, and wherein thickness of each blade intervening between the conical head and the threaded portion is large enough to protect the blades from breakage which the hard materials would otherwise cause,
whereby the threaded portion is capable of tapping a rough hole formed by a drill bit, before the reaming portion enlarges a resultant female-threaded hole to provide a guide hole, such that the head of the screw is forced into the guide hole and buried in the hard material.

2. A self-drilling reaming screw as defined in claim 1, wherein a diameter of the non-threaded shank with the reaming portion protruding therefrom is larger than a diameter of a raw columnar region from which the threaded portion is formed by the rolling.

3. A self-drilling reaming screw as defined in claim 1, wherein the reaming portion is disposed adjacent to the threaded portion.

4. A self-drilling reaming screw as defined in claim 1, wherein the reaming portion is disposed not only adjacent to the proximal end of the threaded portion but also adjacent to a distal end of the conical head.
